(19) United States
(12) Patent Application Publication
(10) Pub. No.: US 2004/0056972 A1
(43) Pub. Date: Mar. 25, 2004

(54) Method for identifying users of a digital camera and digital camera adopting the method

(75) Inventors: Won-Kyu Jang, Seongnam-si (KR); Kun-Sop Kim, Seongnam-si (KR); Yun-Cheal Kim, Seongnam-si (KR); Byoung-Kyu Lee, Seongnam-si (KR)

Correspondence Address: GARDNER CARTON & DOUGLAS LLP, 191 N. WACKER DRIVE, SUITE 3700, CHICAGO, IL, 60606, US

(73) Assignee: Samsung Techwin Co., Ltd., Changwon-city (KR)

(21) Appl. No.: 10/665,178

(22) Filed: Sep. 17, 2003

(30) Foreign Application Priority Data
Sep. 19, 2002 (KR) 2002-57333

(51) Int. Cl. H04N 5/222

(52) U.S. Cl. 348/333.01

(57) ABSTRACT

In a digital camera including an image photographing unit, an image processing unit, a data storing unit, and a recording medium, when multiple users use the digital camera, a user is identified by (a) after the digital camera is turned on according to a command by a user, receiving user identification information, (b) determining whether matched user identification information exists by comparing the input identification information and the user identification information stored in the digital camera, (c) if it is determined that the matched user identification information exists, a setting of the digital camera corresponding to the matched user identification information is loaded, (d) moving an image storing location to an existing folder used by the identified user, (e) the user performing work using the digital camera, and (f) storing a setting state of the camera as information intrinsic to the user according to a turn-off command by the user.

This application claims priority of Korean Patent Application No. 2002-57333 filed on Sep. 19, 2002 in the Korean Intellectual Property Office, the disclosure of which is incorporated herein in its entirety by reference.

### BACKGROUND OF THE INVENTION

1. Field of the Invention

The present invention relates to a digital camera, and, more particularly, to a method for identifying different users of a digital camera and a digital camera adopting the method.

2. Description of the Related Art

When multiple users use a single camera, each user has a preferred setting and typically uses the camera with settings different than other users. In existing cameras, when a setting is initialized or a setting done by the last user is loaded whenever the camera is turned on, it is inconvenient to change the setting of a camera according to different users.

Also, when multiple users use a single digital camera, all photos taken by the users are stored in one folder so that each user has difficulty identifying his or her own photos and one's photos can be seen by other users, raising a privacy issue.

In a conventional digital camera that has a user identification function, a password input to identify a user is compared with a stored password, and only when both passwords are matched can the camera be operated. Also, in the conventional digital camera, when there are multiple users, a process for registration or input of information such as a password to identify a user is simplified.

While some existing digital cameras may require identification information for operation, such cameras do not facilitate or customize use of the camera for each user.

### SUMMARY OF THE INVENTION

To solve the above and other problems, the present invention provides a method for identifying users in a digital camera by utilizing a user identification function to customize a preferred setting and/or an available storage space in a recording medium according to users when multiple users use a single camera.

The present invention provides a digital camera adopting the above user identification method.

According to an aspect of the present invention, a method for identifying users in a digital camera including an image photographing unit photographing an image of an object, an image processing unit performing a predetermined image processing to a photographed image input from the image photographing unit and outputting the processed image, a data storing unit temporarily storing the image output from the image processing unit, and a recording medium inserted in a recording medium interface and storing the digital image data, in which multiple users use the digital camera, the method comprising the steps of (a) after the digital camera is turned on according to a command by a user, receiving user identification information, (b) determining whether matched user identification information exists by comparing the input identification information and the user identification information stored in the digital camera, (c) if it is determined that the matched user identification information exists, a setting of the digital camera corresponding to the matched user identification information is loaded, (d) moving an image storing location to an existing folder used by the identified user, (e) the user performing work using the digital camera, and (f) storing a setting state of the camera as information intrinsic to the user according to a turn-off command by the user.

According to another aspect of the present invention, a digital camera including an image photographing unit photographing an image of an object, an image processing unit performing a predetermined image processing to a photographed image input from the image photographing unit and outputting the processed image, and a data storing unit temporarily storing the image output from the image processing unit, which adopts a method for identifying users in the digital camera by obtaining user identification information and comparing the obtained user identification information with user information stored in the digital camera when multiple users use the digital camera, the digital camera comprising a manipulation unit obtaining and outputting the user identification information by being manipulated by the user, a display unit displaying a message requesting input of the user identification information, the user identification information input through the manipulation unit, and a setting state of the digital camera, a non-volatile storing unit storing the user information and setting information intrinsic to the user with respect to the digital camera and outputting the stored user information and the setting information, a recording medium inserted in a recording medium interface provided in the digital camera and storing the digital image data, and a control unit comparing the user information stored in the non-volatile storing unit and the input user identification information and setting the digital camera according to the setting information stored in the non-volatile storing unit.

### BRIEF DESCRIPTION OF THE DRAWINGS

The above and other features and advantages of the present invention will become more apparent by describing in detail preferred embodiments thereof with reference to the attached drawings in which:

FIG. 1 is a flowchart for explaining a method for identifying users in a digital camera according to a preferred embodiment of the present invention;

FIG. 2 is a flowchart for explaining a preferred embodiment of a step S40 of FIG. 1;

FIG. 3 is a block diagram illustrating the configuration of the digital camera to perform a user identification method according to the present invention; and

FIGS. 4A through 4C are views illustrating the operation of the user identification function in the digital camera according to the present invention.

### DETAILED DESCRIPTION OF THE INVENTION

One feature of the present invention is that a user identification or login function is adopted in a digital camera so that different camera settings corresponding to different users are stored in a memory and a separate image data storing space is designated for each user. Also, it is a feature of the present invention that camera settings that are customized for each identified user are loaded.

According to the present invention, a digital camera for photographing an image of an object includes an image photographing unit, an image processing unit, a data storing unit, and a recording medium. The image photographing unit includes a photographing lens group, a photographing lens group driving mechanism and circuit, and an imaging device such as a CCD or MOS image sensor. The image processing unit, for example, a digital signal processor (DSP), performs a predetermined image process with respect to a photographed image input from the image photographing unit and outputs the processed image. The data storing unit includes a temporary data storing unit and a non-volatile storing unit. The temporary data storing unit temporarily stores digital image data output from the image processing unit while the non-volatile storing unit stores settings and control algorithm of the digital camera. A recording medium may be provided in the form of, for example, a compact flash card, a smart media, a memory stick, etc., which is portable, can be inserted in a recording medium interface provided in the digital camera and can store digital image data.

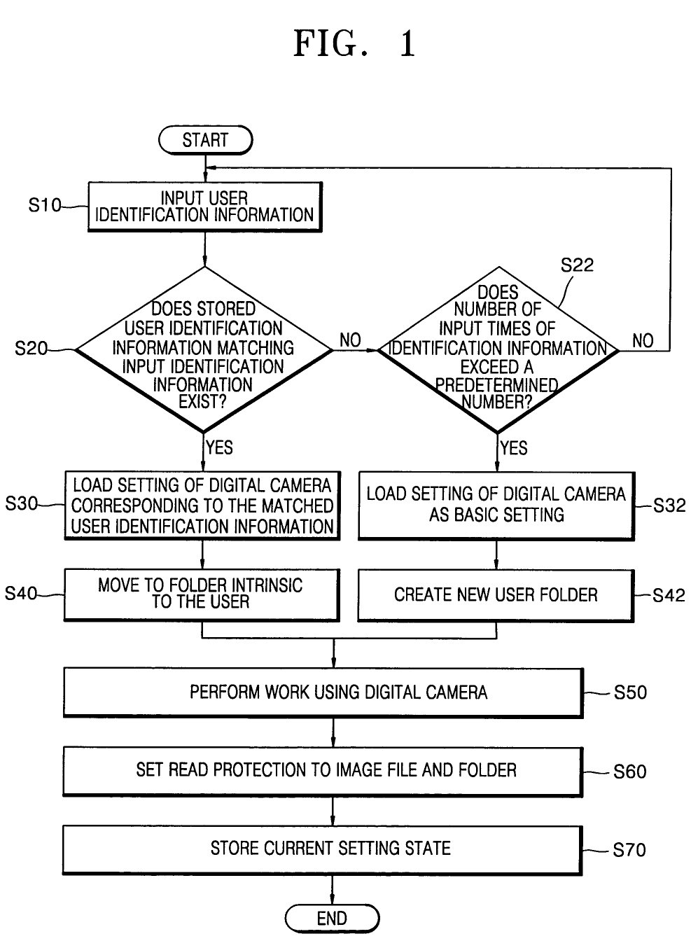

FIG. 1 is a flowchart for explaining a method to identify a user of a digital camera according to a preferred embodiment of the present invention. According to the flowchart, the method includes a user identification information input step (S10), a user identification information comparison step (S20), a user setting loading step (S30), a step to move to intrinsic folder (S40), a user work step (S50), and a current setting storing step (S70). A number of input times of identification information limiting step (S22), a basic setting loading step (S32), a new folder generating step (S42), and a read protection setting step (S60) can be optionally included.

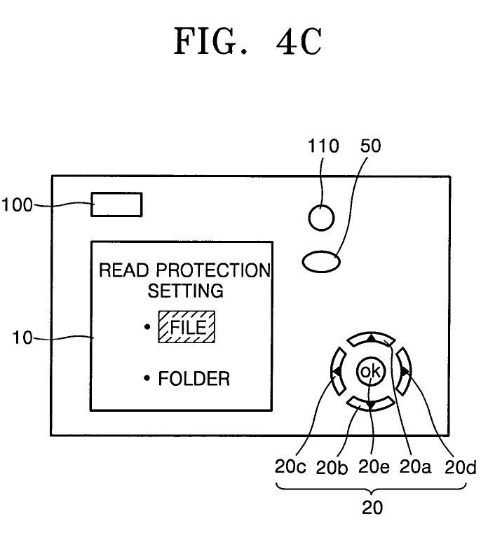

In the user identification information input step (S10), after the digital camera is turned on according to a command by a user, user identification information is input. A method of inputting user identification information is described below with reference to a digital camera according to the present invention shown in FIG. 4A. When a user presses a power switch 110 to operate the digital camera, a message indicating input of user identification information, for example, “Please input four digit password”, is displayed on an LCD panel 10. Then, the user inputs a password by using a manipulation unit 20. The manipulation unit 20 may include an up movement button 20a, a down movement button 20b, a left movement button 20c, a right movement button 20d, and a selection button 20e. In an input method using the manipulation unit 20 having the above structure, a letter or number to be input to each digit of a password is selected by using the up movement button 20a or the down movement button 20b. When a desired letter or number for the first digit where a cursor exists is selected by using the up movement button 20a or the down movement button 20b, the user presses the right movement button 20d to move to the next digit space. The cursor may automatically move to the next digit after a predetermined time passes. The remaining digits of the password are input in the same manner. If a change to the password is needed, the cursor is moved to a desired digit to be changed by using the left movement button 20c or the right movement button 20d and a desired letter or number is input by using the up movement button 20a or the down movement button 20d. When all digits of the password are accurately input by the user, the user presses the selection button 20e to input the password to be displayed on the LCD panel 10. Through such a process, the digital camera obtains input user identification information (S10).

The user identification information comparison step (S20) determines whether matching user identification information exists by comparing the input identification information and user identification information stored in the digital camera. It should be noted that, in Step S20, the user identification information previously stored in the digital camera and the input user identification information are merely compared, but use of the camera is not necessarily prohibited if matching user identification information does not exist. When there is no matching user identification information, normal operation is not initiated and a new user input process may be performed. In other words, if matching user identification information is not found within a limited number of attempts, the process may enter a step essentially establishing a new user for the camera. Step S22 provides a limit, such as three, on the number of attempts to input user identification information without finding a match. Prior to the limit being exceeded, the process proceeds back to Step S10 when matching user identification information is not found that corresponds to the input user identification information. When, in Step S22, the limit is exceeded, the process proceeds to Step S32 described below.

Next, Steps S30 and S40 are described and then Steps S32 and S42 next to Step S22 are described.

In Step S30, if the matching user identification information is determined to exist in Step S20, a setting of the digital camera corresponding to the matched user identification information is loaded.

In Step S40, an image storing location is moved to a folder corresponding to an identified user which exists on a recording medium. This recording medium may exist in a number of formats, and be fixed or may be inserted in a recording medium interface (not shown). The user may employ a new recording medium or a previously used recording medium to store or reproduce photos. If the user employs a previously used recording medium, a folder may already exist where the user's image files are stored. On the other hand, if the user employs a new recording medium, a new folder needs to be created thereon.

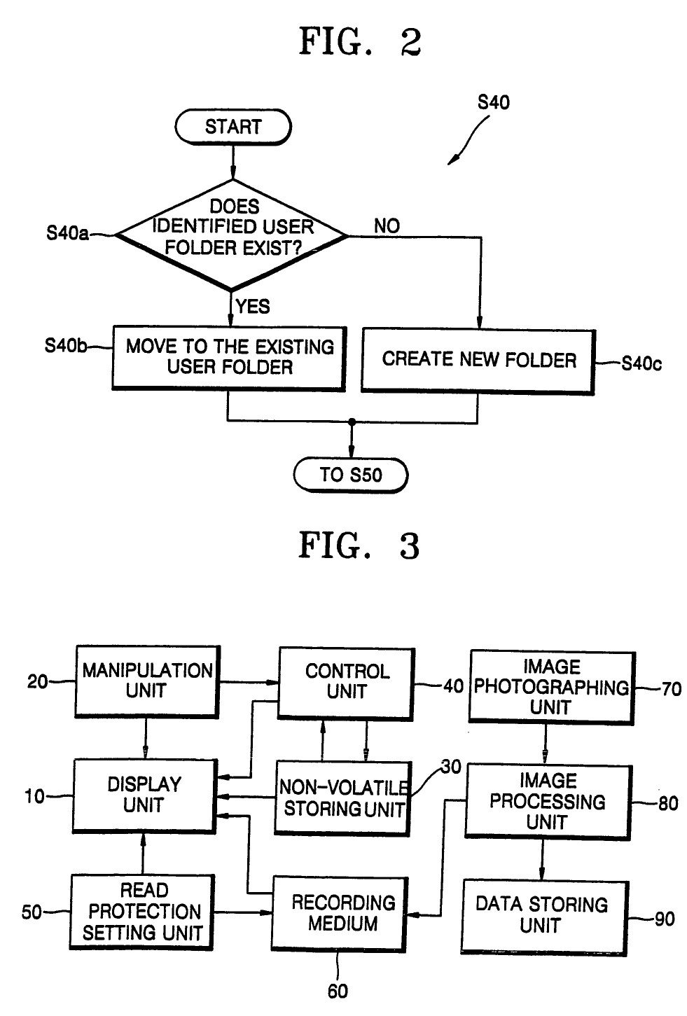

FIG. 2 is a flowchart that explains a preferred embodiment of Step S40 of FIG. 1. First, in Step S40a the digital camera determines whether an existing folder of the identified user is present on the recording medium. If a folder corresponding to the identified user already exists on the recording medium, the camera designates the folder as the image storage location (S40b). If a folder corresponding to the identified user does not exist, a new folder for the user is created as the image storage location (S40c).

In Step S22, the digital camera counts the number of consecutive times that the camera has received input user identification information that does not match any stored user identification information. If the number does not exceed a predetermined value, such as three, the input process begins anew with Step S10. If the number exceeds the predetermined value, then the camera proceeds to Step S32.

In Step S32, the digital camera loads a basic or default setting when no stored user identification information matches the input user identification information input according to Step S20. The basic or default setting may be a recommended setting set by a manufacturer of the digital camera.

After Step S32, the method may optionally include Step S42, in which the camera creates a new user folder. If stored user identification information matching the input user identification information does not exist, because the current user of a camera has not used the camera before, a new user folder needs to be created in the recording medium.

In Step S50, the identified user performs work with the digital camera. The work may include various tasks such as, for example, taking pictures, changing a camera setting, or searching and reading stored photos. Also, the user may simply terminate Step S50. That is, after Step S40, Step 50 is skipped and Step 60 is performed so that read protection can be set with respect to the stored image file or folder.

The user identification method according to the present invention may optionally include a step (S60) of setting read protection with respect to an image file. In Step S60, because multiple users use a single recording medium, images may be divided into two types, open images and non-open images. Either particular image files or entire folders may be designated as non-open. Read protection can be set for particular non-open images or a user's entire non-open folder. The digital camera, according to a preferred embodiment of the present invention, may further include a read protection setting unit 50 to perform Step S60. When a read protection function is performed according to a command by the user using the read protection setting unit 50, an image file or folder subject to the read protection can be accessed by a particular user through input of a password.

In Step S70, the setting of the camera is stored as information corresponding to the user. This step may take place in conjunction with a turn-off command by the user. The items to be stored with respect to the current user identification information may include various settings for photograph and user folder information.

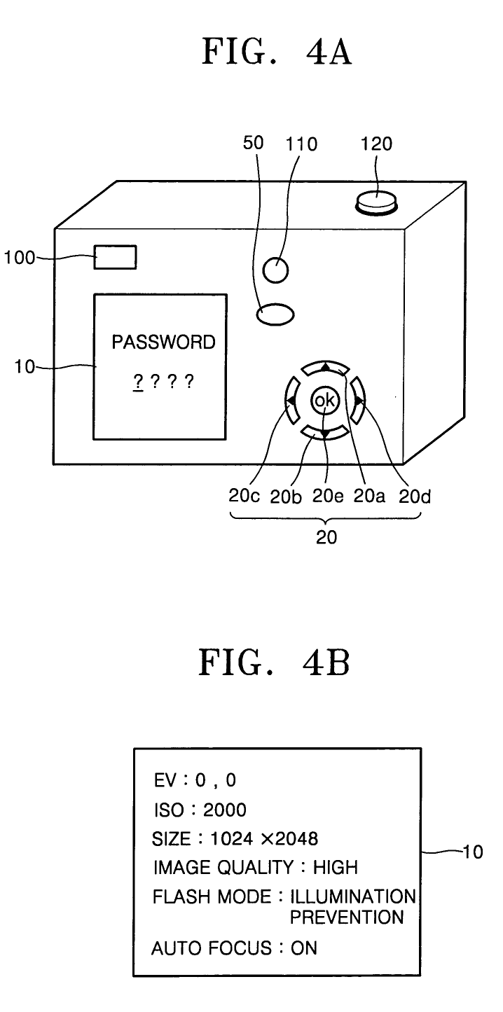

FIG. 3 is a block diagram illustrating the configuration of a digital camera that performs a user identification method according to the present invention. Referring to FIG. 3, the digital camera includes an image photographing unit 70 to take photos of an object, an image processing unit 80 to perform a predetermined image process that inputs an image from the image photographing unit 70 and outputs digital image data, a data storing unit 90 to temporarily store the image processed by and output from the image processing unit 80, a display unit 10, a manipulation unit 20, a non-volatile storing unit 30, a control unit 40, and a recording medium 60.

The display unit 10 displays a message indicating input of user identification information, the user identification information input by the manipulation unit 20, and setting state of the digital camera. The display unit 10 may be an LCD (liquid crystal display). A message indicating input of user identification information, such as “Please input password” or “Password: ????”, can be displayed on the display unit 10. Also, in addition to the user identification function, the display unit 10 may include a function of displaying a photographed image.

The manipulation unit 20 obtains user identification information via manipulation by the user. The manipulation unit 20 includes a plurality of direction setting buttons and a selection button, or a plurality of numeric keys and function keys used to set functions on a menu, and generates and outputs key data corresponding to the user identification information when the user manipulates the keys. The manipulation unit 20, as shown in FIG. 4A, may include the up movement button 20a, the down movement button 20b, the left movement button 20c, the right movement button 20d, and the selection button 20e. One of ordinary skill in the art will easily recognize that other configurations are possible.

The non-volatile storing unit 30 stores user information and setting information corresponding to a user. The non-volatile storing unit 30 can also output the stored user information and setting information. Because the capacity of the non-volatile storing unit 30 included in the digital camera is finite, the stored user information may be updated in a first-in-first-out manner or user information that is not used for a predetermined period, for example, a month, may be automatically deleted.

The control unit 40 determines whether the user information stored in the non-volatile storing unit 30 matches the user identification information input by the manipulation unit 20. The control unit 40 may adjust the digital camera settings according to the setting information corresponding to the user that is stored in the non-volatile storing unit 30.

The recording medium 60 is any medium capable of storing digital information. This includes such media as a compact flash card, a smart media, or a memory stick, which are portable and insertable into a recording medium interface provided in the digital camera to store digital image data.

The digital camera according to the present invention may optionally include the read protection setting unit 50. The read protection function is performed as follows by using the read protection setting button 50, the display unit 10, and the manipulation unit 20. When the user presses the read protection setting button 50, a list of the image files or folder stored in the recording medium 60 is displayed on the display unit 10. The user designates and selects an image file or folder subject to the read protection by using the manipulation unit 20. The selected image file is designated as read protection. The read protection setting unit may set read protection with respect to an image file taken by the user and input to the non-volatile storing unit 30 or to be input thereto.

FIGS. 4A through 4C are views illustrating the operation of the user identification function in the digital camera according to the present invention. Referring to FIGS. 4A through 4C, the operations of identification of users, loading of a setting, and setting of read protection of a folder/image file in an LCD of the digital camera according to the present invention are described below.

FIG. 4A shows an outer appearance of the digital camera according to a preferred embodiment of the present invention. In FIG. 4A, reference numerals 100 and 120 denote a viewfinder and a shutter (a release button), respectively. When a user presses the power button 110 to turn on the camera, as shown in FIG. 4A, an input screen for identification of a user is displayed on the LCD display unit 10. That is, a message “Password: ????” is displayed to input a password having a predetermined number of digits for user login. When the message is displayed, the password is input by using the up movement button 20a, the down movement button 20b, the left movement button 20c, the right movement button 20d, and the selection button 20e of the manipulation unit 20. A desired letter or number to be input to the first digit where a cursor exists is selected by using the up movement button 20a or the down movement button 20b. Then the cursor is moved to the next digit by pressing the right movement button 20d. The password is input to the remaining digits in the same manner. When there is a change to the password, the password is changed by using the left movement button 20c or the right movement button 20d. When all digits of the password are accurately selected, the user presses the selection button 20e so that the password displayed on the LCD panel 10 is obtained as user identification information.

When login is successfully performed with the stored user information and the input password being matched, as shown in FIG. 4B, a setting stored in the non-volatile memory included in the digital camera is loaded for an existing user. A basic setting is loaded for a new user.

In the case of an existing user, an existing folder of the user is recognized on a recording medium according to information corresponding to the user stored in the non-volatile memory included in the digital camera. Newly photographed or inputted images are stored in the existing folder of the user. If a corresponding folder does not exist in the recording medium although the user is an existing user, a new folder is created.

Referring to FIG. 4C, when login is successfully performed, a “read protection” function can be set with respect to a folder and an image file. To set the read protection function, the read protection setting button 50 is used. The user designates an image file or folder by using the manipulation unit 20 and sets the designated image file or folder as “read protection” while viewing a list displayed on the LCD panel 10.

As described in the method above, when multiple users use a single digital camera, the operation of the digital camera can be controlled through user identification. By customizing a camera setting for each user and creating a personal folder, confusion and inconvenience according to use of a single camera by multiple users can be avoided. Furthermore, by providing various functions such as a read protection function to one's own folder and image file, users can be distinguished from one another and personal information can be protected from other users.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A method for identifying users in a digital camera including an image photographing unit photographing an image of an object, an image processing unit performing a predetermined image processing to a photographed image input from the image photographing unit and outputting the processed image, a data storing unit temporarily storing the image output from the image processing unit, and a recording medium inserted in a recording medium interface and storing the digital image data, in which multiple users use the digital camera, the method comprising the steps of:
(a) after the digital camera is turned on according to a command by a user, receiving user identification information;
(b) determining whether matched user identification information exists by comparing the input identification information and the user identification information stored in the digital camera;
(c) if it is determined that the matched user identification information exists, a setting of the digital camera corresponding to the matched user identification information is loaded;
(d) moving an image storing location to an existing folder used by the identified user;
(e) the user performing work using the digital camera; and
(f) storing a setting state of the camera as information intrinsic to the user according to a turn-off command by the user.

2. The method as claimed in claim 1, wherein Step (d) comprises the sub-steps of:
(d1) after Step (c), determining whether an existing folder used by the identified user exists;
(d2) if it is determined that the existing folder used by the identified user exists, moving to the existing folder; and
(d3) otherwise, creating a new folder for the user.

3. The method as claimed in claim 1, further comprising Step (g) of, if it is determined in Step (b) that the input identification information does not match the stored user information, determining whether the frequency of input of the user identification information exceeds a predetermined number and, if it is determined that the frequency does not exceed the predetermined number, moving to Step (a).

4. The method as claimed in claim 1, further comprising steps of:
(h) if it is determined in Step (b) that the input identification information does not match the stored user information, loading a setting of the digital camera as a basic setting; and
(i) creating a new user folder.

5. The method as claimed in claim 1, wherein a step of setting read protection with respect to an image file stored in the user folder, or to be stored therein, and the user folder, is provided after Step (e).

6. A digital camera including an image photographing unit photographing an image of an object, an image processing unit performing a predetermined image processing to a photographed image input from the image photographing unit and outputting the processed image, and a data storing unit temporarily storing the image output from the image processing unit, which adopts a method for identifying users in the digital camera by obtaining user identification information and comparing the obtained user identification information with user information stored in the digital camera when multiple users use the digital camera, the digital camera comprising
a manipulation unit obtaining and outputting the user identification information by being manipulated by the user;
a display unit displaying a message requesting input of the user identification information, the user identification information input through the manipulation unit, and a setting state of the digital camera;
a non-volatile storing unit storing the user information and setting information intrinsic to the user with respect to the digital camera and outputting the stored user information and the setting information;
a recording medium inserted in a recording medium interface provided in the digital camera and storing the digital image data; and
a control unit comparing the user information stored in the non-volatile storing unit and the input user identification information and setting the digital camera according to the setting information stored in the non-volatile storing unit.

7. The digital camera as claimed in claim 6, further comprising a read protection setting unit setting read protection with respect to an image file photographed by the user and input to the non-volatile storing unit or to be input thereto.
